(19) United States
(12) Patent Application Publication
(10) Pub. No.: US 2014/0067302 A1
(43) Pub. Date: Mar. 6, 2014

(54) PRODUCT RELIABILITY ESTIMATION

(71) Applicants: Jeanne P. BICKFORD, Essex Junction, VT (US); Rebecca A. BICKFORD, Essex Junction, VT (US); Pascal A. NSAME, Essex Junction, VT (US)

(72) Inventors: Jeanne P. BICKFORD, Essex Junction, VT (US); Rebecca A. BICKFORD, Essex Junction, VT (US); Pascal A. NSAME, Essex Junction, VT (US)

(73) Assignee: INTERNATIONAL BUSINESS MACHINES CORPORATION, Armonk, NY (US)

(21) Appl. No.: 13/605,168

(22) Filed: Sep. 6, 2012

(51) Int. Cl. G06F 19/00

(52) U.S. Cl. 702/81

(57) ABSTRACT

Methods and systems for systems and methods for product reliability estimation are provided. A method implemented in a computer infrastructure includes separating products into different process window segments. The method also includes calculating a product reliability estimation for each process window segment. The method further includes calculating a system product reliability estimation. At least one of the separating, calculating the product reliability estimation, and calculating the system product reliability estimation is performed using a processor.

### FIELD OF THE INVENTION

The invention relates to semiconductor devices and, more particularly, to systems and methods for product reliability estimation.

### BACKGROUND OF THE INVENTION

Power consumption of integrated circuit devices (e.g., complementary metal oxide semiconductors (CMOS)) consists of two components: dynamic power (i.e., active power) and leakage power (i.e., static power). Dynamic power is the power required to switch the state of a device (i.e., to change the binary state of one or more device components from high to low or low to high). The dynamic power is a function of capacitance, voltage, and switching frequency (e.g., P=CVⁿF, where P is the dynamic power, C is an effective switch capacitance, V is a supply voltage, n is a coefficient greater than 2, and F is the switching frequency). Leakage power is the power consumed by a device when it is powered but not switching. In an integrated circuit device composed primarily of metal oxide semiconductor field effect transistors, the leakage power is an exponential function of the supply voltage. As the dimensions in a technology decrease, the static power of devices increases, and as a result, the overall power consumption also increases. Thus, in fabrication processes, it is important to estimate the power of integrated circuits.

Reliability estimates can be calculated for a given population of products over a lifetime of the products, e.g., integrated circuits. Current product reliability estimations of integrated circuits are based on one system operating condition for all parts, e.g., worst case conditions or nominal conditions. However, system use conditions are different for fast versus slow products when using selective voltage binning (SVB). More specifically, in selective voltage binning (SVB) systems, a lower operating voltage is required for faster parts and a higher operating voltage is required for slower parts. As a result, product reliability estimations do not accurately reflect the reliability of all of the products because the products operate at different operating conditions, e.g., different voltages.

Accordingly, there exists a need in the art to overcome the deficiencies and limitations described hereinabove.

### SUMMARY OF THE INVENTION

In a first aspect of the invention, a method implemented in a computer infrastructure comprises separating products into different process window segments. The method also comprises calculating a product reliability estimation for each process window segment. The method further comprises calculating a system product reliability estimation. At least one of the separating, calculating the product reliability estimation, and calculating the system product reliability estimation is performed using a processor.

In another aspect of the invention, a computer program product comprising a computer readable storage memory device having readable program code embodied in the computer readable storage memory device is provided. The computer readable program, when executed on a computing device, is operable to cause the computing device to divide a manufacturing process window into process window segments based on an applied planned manufacturing distribution. The computer readable program also causes the computing device to identify a system use condition for each process window segment and calculate an expected amount of product in each of the process window segments, wherein the expected amount is a distribution percentage. The computer readable program further causes the computing device to calculate a product reliability estimation for each process window segment based on the system use condition of each respective process window segment and calculate system product reliability estimation based on the product reliability estimation for each process window segment.

In yet another aspect of the invention, a computer system for calculating a system product reliability estimation comprises a CPU, a computer readable memory and a tangible computer readable storage media. The computer system comprises first program instructions to divide a manufacturing process window into process window segments based on an applied planned manufacturing distribution. The computer system also includes second program instructions to identify a system use condition for each process window segment and third program instructions to calculate an expected amount of product in each of the process window segments, wherein the expected amount is a distribution percentage. The computer system further includes fourth program instructions to calculate a product reliability estimation for each process window segment based on the system use conditions of each respective process window segment, and fifth program instructions to calculate the system product reliability estimation. The first, second, third, fourth, and fifth program instructions are stored on the computer readable storage media for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing steps in accordance with aspects of the present invention;

FIG. 2 shows a graph illustrating total power versus device delay for an exemplary set of voltage bins in accordance with aspects of the present invention;

FIG. 3 shows a graph of product reliability in accordance with aspects of the present invention;

FIG. 4 shows a graph of a Gaussian distribution curve in accordance with aspects of the present invention;

FIG. 5 shows a graph of a Gaussian distribution curve with a screening line in accordance with aspects of the present invention;

FIG. 6 shows an exemplary redistribution of screened process window segments of the Gaussian distribution curve in accordance with aspects of the present invention; and

FIG. 7 shows an exemplary flow chart for performing aspects of the present invention.

### DETAILED DESCRIPTION

The invention relates to semiconductor devices and, more particularly, to systems and methods for product reliability estimation. The present invention advantageously provides for accurate product reliability estimation. More specifically, by using a distribution method, the present invention can separate products into different process window segments and accurately predict a number of products in each process window segment (also referred to herein as a bin). Moreover, the present invention can identify a system use condition for each process window segment and calculate product reliability for each process window segment. In this way, the present invention can use “by bin” system voltages, which can compensate for variability in product reliability with minimal impact on an overall system.

More specifically, according to aspects of the present invention, a manufacturing process window can be divided into pre-identified process window segments. A planned manufacturing distribution, e.g., a Gaussian distribution, is applied to the manufacturing process window and an expected amount of product in each distribution process window segment, e.g., a distribution percentage, can be calculated. In embodiments of the present invention, the Gaussian distribution curve may be divided into a number of process window segments, and a subset of the process window segments may be screened to determine a redistributed Gaussian distribution. Moreover, a system product reliability can be calculated according to aspects of the present invention. More specifically, the distribution percentage for each process window segment is multiplied by the product reliability for each process window segment, and the system product reliability is calculated by summing the product reliability for each process window segment.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (also referred to as a computer readable storage memory device). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

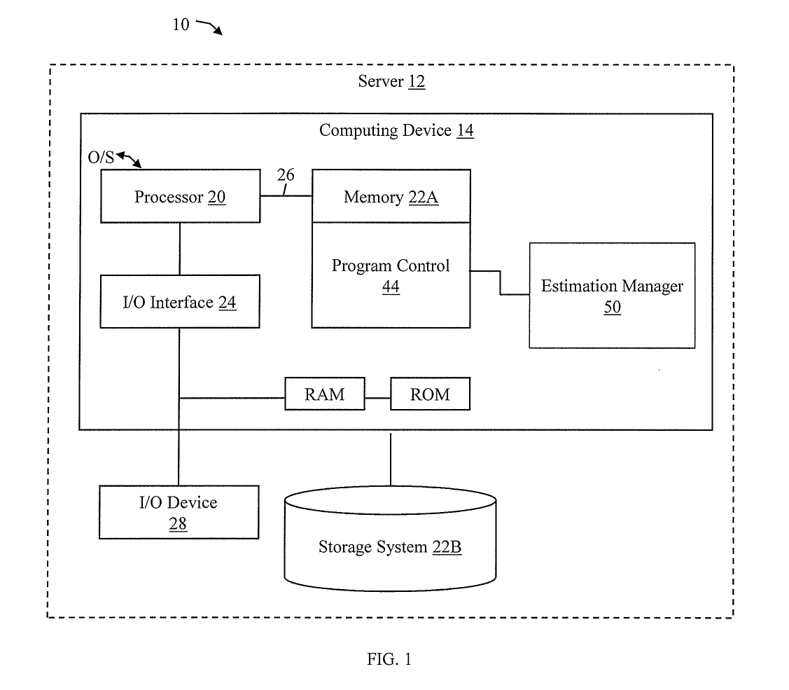

FIG. 1 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with an external I/O device/resource 28 and a storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls an estimation manager 50 that is configured to perform the processes described herein. For example, the estimation manager 50 can separate manufacturing process windows into pre-identified process window segments and apply planned manufacturing distributions to calculate an expected amount of product in each process window segment, e.g., a distribution percentage. Furthermore, the estimation manager 50 can identify a system use condition, e.g., a voltage, temperature, or both, for each process window segment and calculate a product reliability for each process window segment based on the system use condition. The estimation manager 50 can also calculate a total SVB adjusted reliability based on the reliability for each process window segment.

The estimation manager 50 can be implemented as one or more program code in the program control 44 stored in memory 22A as separate or combined modules. Additionally, the estimation manager 50 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

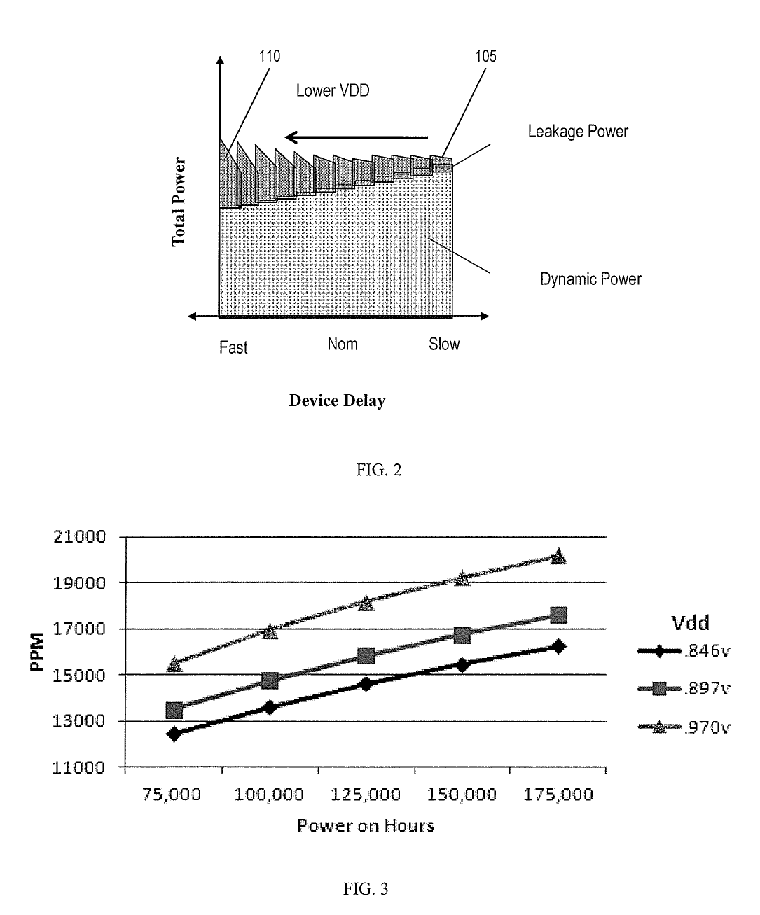

FIG. 2 shows a graph illustrating total power versus device delay for an exemplary set of voltage bins. The total power of each voltage bin is a combination of the dynamic power and the leakage power when operated at the respective supply voltage of the voltage bin. The device delay of each voltage bin corresponds to a system delay for a range of devices manufactured according to the same design. Devices that are “slow” have larger device delay with respect to a nominal (i.e., average) one of the devices operating at the same supply voltage. Devices that are “fast” have a smaller delay with respect to a nominal one of the devices operating at the same supply voltage. Accordingly, the fastest devices (e.g., about −3.0 sigma) are placed in the voltage bin 110 and the slowest devices (e.g., about +3.0 sigma) are placed in the voltage bin 105. For example, as shown in Table 1, products operating at lower voltages have a lower, i.e., faster sigma than products operating at higher voltages, e.g., products in bin 1, e.g., voltage bin 110 operate at a voltage of about 0.825V to 0.867 and have a sigma of about −2.63 to −3.00, whereas, products in bin 16, e.g., voltage bin 105, operate at a voltage of about 0.946V to 0.970V and have a sigma of about 2.63 to 3.00.

TABLE 1

| | |
|---|---|
| Voltage at package ball | sigma |

| Bin | min | nom | max | slow | fast |
|---|---|---|---|---|---|
| 1 | 0.825 | 0.846 | 0.867 | −2.63 | −3.00 |
| 2 | 0.833 | 0.854 | 0.876 | −2.25 | −2.63 |
| 3 | 0.841 | 0.863 | 0.884 | −1.88 | −2.25 |
| 4 | 0.849 | 0.871 | 0.893 | −1.50 | −1.88 |
| 5 | 0.857 | 0.879 | 0.901 | −1.13 | −1.50 |
| 6 | 0.865 | 0.887 | 0.910 | −0.75 | −1.13 |
| 7 | 0.873 | 0.896 | 0.918 | −0.38 | −0.75 |
| 8 | 0.881 | 0.904 | 0.926 | 0.00 | −0.38 |
| 9 | 0.889 | 0.912 | 0.935 | 0.38 | 0.00 |
| 10 | 0.897 | 0.920 | 0.943 | 0.75 | 0.38 |
| 11 | 0.905 | 0.929 | 0.952 | 1.13 | 0.75 |
| 12 | 0.914 | 0.937 | 0.960 | 1.50 | 1.13 |
| 13 | 0.922 | 0.945 | 0.969 | 1.88 | 1.50 |
| 14 | 0.930 | 0.953 | 0.977 | 2.25 | 1.88 |
| 15 | 0.938 | 0.962 | 0.986 | 2.63 | 2.25 |
| 16 | 0.946 | 0.970 | 0.995 | 3.00 | 2.63 |

Each of the voltage bins is associated with a corresponding supply voltage determined to improve their respective performance and/or power consumption. That is, slow voltage bins are operated at progressively higher supply voltages (i.e., higher VDD) to improve their device delay; whereas, faster bins are operated at progressively lower supply voltages (i.e., lower VDD) to reduce their power consumption. Moreover, in embodiments, these bins can also be used to calculate an adjusted product reliability estimate. Notably, FIG. 2 illustrates twelve voltage bins; however, any number of bins can be used (e.g., 16 bins as shown in Table 1).

FIG. 3 shows a graph of product reliability in accordance with aspects of the present invention. In FIG. 3, an x-axis represents a power on hours of products and a y-axis represents a fail rate, e.g., PPM, of the products. More specifically, FIG. 3 shows products operating at three operating voltages. As an example, these operating voltages can be 0.846V, 0.897V, and 0.970V. As can be seen in FIG. 3, products with higher operating voltage have higher fail rates than products with lower operating voltages. For example, products with an operating voltage of 0.970V have 15,503 fails at 75,000 Power on Hours (POH), whereas products with an operating voltage of 0.846V have 12,437 fails at 75,000 POH, which is described further with reference to Table 2 below. Failure rates at use conditions are commonly calculated from accelerated stress data by assigning an exponential distribution and converting the data from stress time to equivalent use hours using voltage and temperature acceleration factors. For example, failure rates can be calculated in accordance with equation 1.

λ=χ²(2n+2,1−α)*10⁹/(2*ss*t*AF) (1)

Where λ is the failure rate in FITs (failures per billion unit-hours), χ²(2n+2, 1−a)/2 is an upper confidence value for “n” failures and an upper confidence limit, 2n+2 is a degrees of freedom, and 1− is a probability, which is expressed as a decimal value. In addition, ss is a sample size of a circuit, t is a test duration in hours, and AF is a total acceleration factor related to life test conditions, e.g., a junction temperature AF_{T}, voltage AF_{V}, etc., of assumed field conditions, i.e., AF=AF_{T}+AF_{V}+ . . . . The χ² (chi-squared) value for 2n+2 degrees of freedom and the 1−α a probability can be obtained from a table or calculated using a chi-squared inverse function of a mathematical modeling tool. To better understand the concept of confidence levels, assume that a life test on a 100 part sample from a certain product population had one failure and a desired 60% confidence level. The chi-squared value corresponding to one failure at 60% confidence is 2.02. This means that one has a 60% confidence that a “true” value of a population's defect rate is between zero (or a very small value) and 2.02%.

Reliability failure rates for logic monitors are reported in FIT per million circuits (xx FIT/M), where xx is the failures in time expressed in parts per million (ppm) per thousand power-on hours (KPOH) and M is one million circuits. This value is determined by dividing the failure rate for the part used to perform the monitor by the circuit count in that part.

Product reliability data is typically composed of several different failure mechanisms that can contribute to failures differently as a function of voltage and temperature. When projecting reliability performance at actual use conditions compared to accelerated test data, contribution of individual defect mechanisms with unique voltage and temperature kinetics behavior must be reflected in product failure-rate projections. This is particularly important when the accelerated stress failure mix includes mechanisms with relatively low acceleration, such as resistive failures. In the absence of such mechanisms, it is common practice to use voltage and temperature acceleration factors that combine all mechanisms into a composite model. Temperature acceleration for semiconductor failure mechanisms is usually determined by the Arrhenius equation as should be understood by those of ordinary skill in the art and shown in equation 2.

AF_{T}=exp[(−Ea/k)*(1/Tᵤ−1/Tₛ) (2)

Where Ea is an activation energy in eV, k is Boltzmann's constant (8.62×10⁻⁵ eV/K), Tᵤ is a use temperature in Kelvin, and Tₛ is a stress temperature in Kelvin. For modeling evaluations conducted during product qualifications, voltage acceleration is described by equation 3.

AFv=exp[γ*(Vₛ−Vᵤ)] (3)

Where γ is a voltage acceleration term in 1/V, Vₛ is a stress voltage in volts, and Vᵤ is a use voltage in volts.

For example, as shown in Table 2, a product with an operating voltage Vdd of 0.970V has 15,503 fails at 75,000 Power on Hours (POH), a product with an operating voltage of 0.897V has 13,496 fails at 75,000 POH, and a product with an operating voltage of 0.846V has 12,437 fails at 75,000 POH. Thus, as shown in FIG. 3 and Table 2, products with lower operating voltages have fewer fails than products with higher operating voltages. Therefore, to accurately estimate the overall reliability of semiconductors, it is advantageous to evaluate products with different operating voltages separately.

TABLE 2

| | Fails (PPM) @105 C | | |
|---|---|---|---|
| | Vdd (Vcs = 1.013) | | |
| POH | .846 v | .397 v | .970 v |
| 75,000 | 12437 | 13496 | 15503 |
| 100,000 | 13606 | 14761 | 16947 |
| 125,000 | 14591 | 15825 | 18161 |
| 150,000 | 15449 | 16752 | 19219 |
| 175,000 | 16215 | 17579 | 20162 |

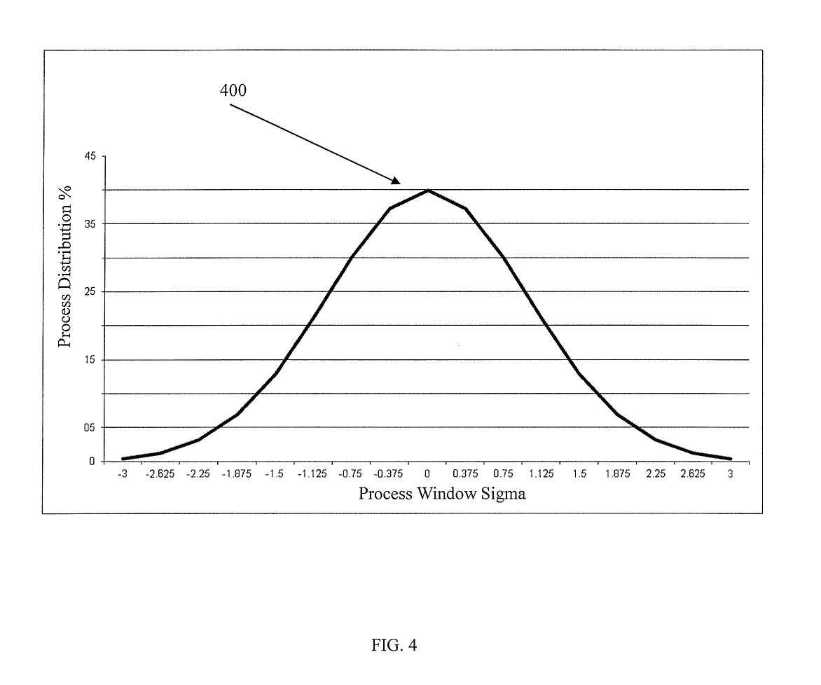

FIG. 4 shows a graph of a Gaussian distribution curve 400 according to aspects of the present invention. In FIG. 4, an x-axis represents a process window sigma and a y-axis represents a process distribution percentage. More specifically, according to aspects of the present invention, the Gaussian distribution curve 400 is used to determine a distribution of products in a manufacturing process. In embodiments, the Gaussian distribution curve 400 is determined using the formula of equation 4.

f(x)=(e^{-(x-μ)}^{²}^{/2σ}^{²})/(2πσ²)^{1/2}, where μ=0, σ²=1 (4).

Although the distribution of products is determined using Gaussian distribution, it is contemplated that alternative distribution methods are also contemplated by the present invention. For example, a histogram of a normal probability curve can be visually analyzed to look for a symmetrical, bell-shaped distribution with no outliers. For larger samples, the histogram can resemble a normal distribution.

Alternatively, a normal probability plot, e.g., a Quantile-Quantile plot, compares sample data against expected values for a normal distribution with a mean and variance of the sample data. The resulting plotted values can be well fitted by a straight line as indicated by a correlation for a line fitted to the plot. In embodiments, statistical tests for a goodness of a line can be used to determine if the correlation is significant and thus suggest agreement with the distribution being normal. Moreover, statistical tools include functions which can be used to produce these plots, fit a line, and determine if the correlation indicates a good fit. In still further, embodiments, other statistical goodness of fit tests can be used to determine that a sample of data is drawn from a normal probability distribution. The appropriate usage of these tests varies for different situations and the tests vary in effectiveness based on the sample size. These tests include, but are not limited to, chi-squared tests, the Kolmogorov-Smirnov test, the Lilliefors test, and the Shapiro-Wilk test, all of which are known to those of ordinary skill in the art such that further explanation is not required.

In embodiments, the graph of the Gaussian distribution curve 400 is divided into predefined process window segments. In this way, a percentage of products in each process window segment can be determined using the Gaussian distribution curve 400. For example, as shown in Table 3, the Gaussian distribution curve 400 can be divided into 16 process window segments and a percentage of each product can be determined for each process window segment. Although Table 3 shows the Gaussian distribution curve 400 divided into 16 bins, the Gaussian distribution curve may be divided into any number of bins because the Gaussian distribution curve 400 is infinitely divisible as should be understood by those of ordinary skill in the art.

TABLE 3

| Bin Number | Percentage of Products |
|---|---|
| 15 | 0.298 |
| 14 | 0.789 |
| 13 | 1.817 |
| 12 | 3.641 |
| 11 | 6.349 |
| 10 | 9.633 |
| 9 | 12.72 |
| 8 | 14.617 |
| 7 | 14.617 |
| 6 | 12.72 |
| 5 | 9.633 |
| 4 | 6.349 |
| 3 | 3.641 |
| 2 | 1.817 |
| 1 | 0.789 |
| 0 | 0.298 |

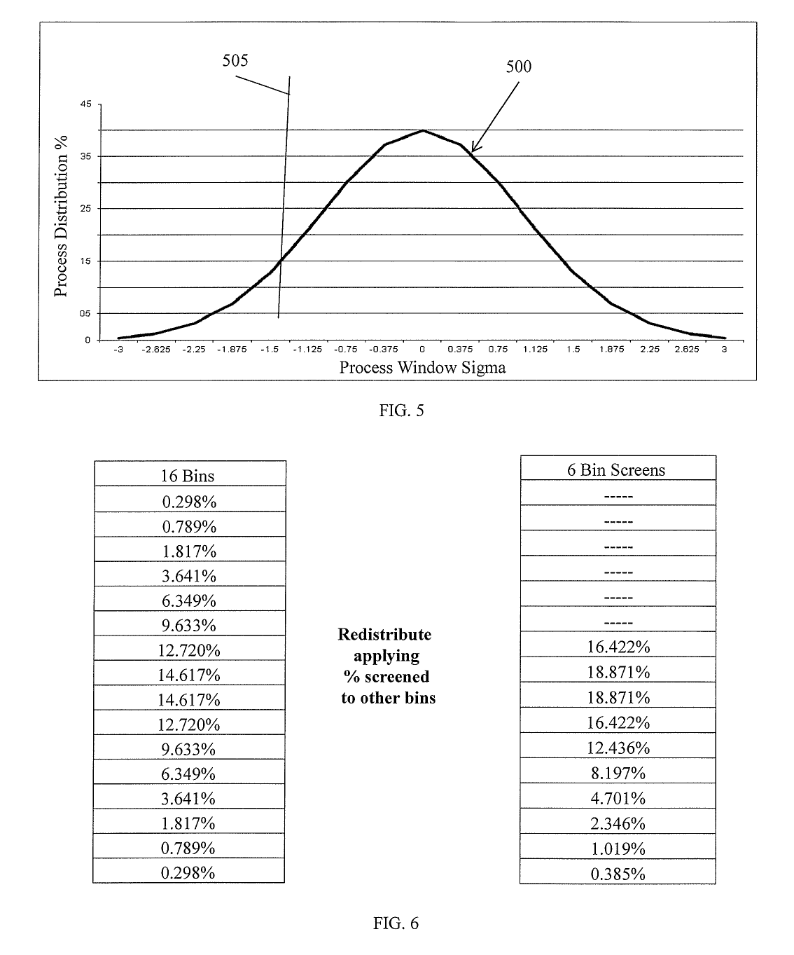

FIG. 5 shows a graph of a Gaussian distribution curve 500 with a screening line 505 according to aspects of the present invention. More specifically, in embodiments, the screening line 505 can be used to screen a performance distribution window of the Gaussian distribution curve of FIG. 4. That is, the screening line 505 can be used to exclude a number of bins from the distribution of products. For example, a screen point, e.g., the screening line 505, is selected and a ratio multiplier is identified based on the selected screening point. An updated distribution curve is calculated using the ratio multiplier. More specifically, the ratio multiplier and updated Gaussian distribution curve are calculated using the following equations:

100%−(% in Screened Bin)=S(Shipped Distribution) (5);

100%/S=Rₘ(ratio multiplier) (6); and

Update expected value based=Bin value×Rₘ (7).

FIG. 6 shows an exemplary redistribution of screened process window segments in accordance with aspects of the present invention. More specifically, products in screened process window segments are redistributed into all remaining process window segments using equations (5)-(7). For example, as shown in FIG. 6, six process window segments are screened and the percentage of products in the remaining process window segments can be updated. More specifically, in embodiments, the percentage of products in the screened process window segments is 22.527% (i.e., the sum of the percentage of products in the screened process window segments), and as such, S=77.473% (e.g., 100%−22.527%) and Rₘ=1.291 (e.g., 100%/77.473%), as calculated using equations (5) and (6), respectively.

Accordingly, the percentage of products in the remaining process window segments can be updated by multiplying the percentage of products in the remaining process window segments by 1.291. For example, as shown in FIG. 6, a percentage of products in a last process window segment, i.e., bin 16, increases from 0.298% to 0.385%, e.g., 0.298%×1.291. Although FIG. 6 shows the Gaussian distribution curve divided into 16 bins with 6 bins being screened, it is contemplated that the Gaussian distribution curve may be divided into any number of bins and that any number of bins may be screened in accordance with aspects of the present invention.

### Flow Diagram

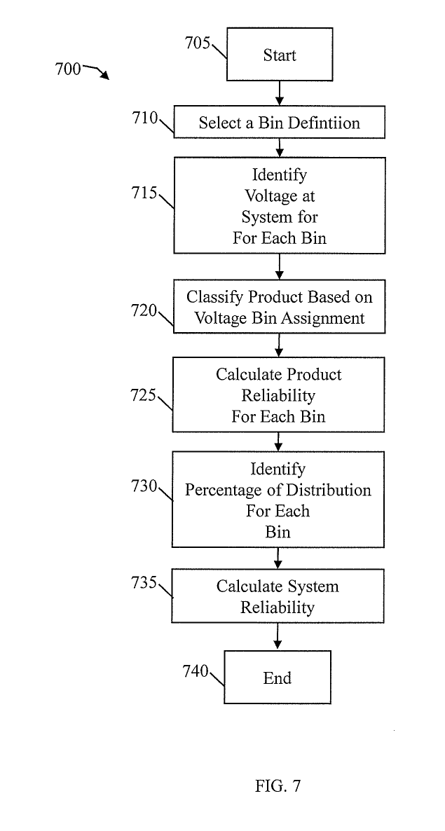

FIG. 7 shows exemplary flows for performing aspects of the present invention. The steps of FIG. 7 may be implemented in the environment of FIG. 1, for example. The flowchart and block diagrams in the Figure illustrate the architecture, functionality, and operation of possible implementations of systems, methods and computer program products according to various embodiments of the present invention. In this regard, each block in the flowchart or block diagrams may represent a module, process window segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 7 depicts an exemplary flow for a process in accordance with aspects of the present invention. As shown in FIG. 7, at step 705, the process of the invention begins. The process includes, at step 710, selecting a bin definition as already known by those of ordinary skill in the art and disclosed in, for example, U.S. Pat. No. 7,475,336 and U.S. Pat. No. 8,141,012, the contents of which are incorporated by reference herein in their entirety. At step 715, the process includes identifying a system operating condition for each bin. For example, in embodiments, the system can include a voltage, a temperature, or both. More specifically, in selective voltage binning (SVB), products operating at slower frequencies require higher operating voltages; whereas, products operating at higher frequencies require lower operating voltages in order to maintain a consistent product performance requirement as should be understood by those of ordinary skill in the art. In this way, according to aspects of the present invention, a more accurate product reliability estimation can be achieved by using the lowest voltage for each respective bin that meets product performance requirements.

At step 720, the process further includes classifying a product based on a voltage bin assignment of the product. The process also includes calculating a product reliability estimation for each bin, at step 725. In embodiments, the product reliability estimation for each bin is calculated using equation 1. The process further includes identifying the distribution percentage for each process window segment, at step 730. More specifically, as discussed herein, the distribution for each process window segment may be based on a Gaussian distribution curve, which can be divided into any number of process window segments. Alternatively, the Gaussian distribution curve may be divided into a number of process window segments, and a subset of the process window segments may be screened to determine a redistributed Gaussian distribution. At step 735, a system product reliability is calculated. More specifically, the distribution percentage for each process window segment is multiplied by the product reliability calculated at step 725 to determine a bin product reliability for each process window segment, and the SVB product reliability is calculated by summing the product reliability for each process window segment. At step 740, the process ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method implemented in a computer infrastructure, the method comprising:
separating products into different process window segments;
calculating a product reliability estimation for each process window segment; and
calculating a system product reliability estimation, wherein at least one of the separating,
calculating the product reliability estimation, and calculating the system product reliability estimation is performed using a processor.

2. The method of claim 1, wherein separating the products into different process window segments comprises:
applying a planned manufacturing distribution to a manufacturing process window;
dividing the manufacturing process window into the process window segments based on the planned manufacturing distribution; and
calculating an expected amount of product in each of the process window segments, wherein the expected amount is a distribution percentage.

3. The method of claim 2, wherein calculating the system product reliability estimation comprises:
calculating a product reliability for each process window segment by multiplying the distribution percentage for each process window segment by the product reliability estimation calculated for each process window segment; and
summing the product reliability for each process window segment.

4. The method of claim 3, wherein the planned manufacturing distribution is a Gaussian distribution curve.

5. The method of claim 4, further comprising:
screening a subset of the process window segments; and
determining a redistributed Gaussian distribution curve.

6. The method of claim 5, wherein determining the redistributed Gaussian distribution curve comprises:
calculating a ratio multiplier based on a selected screening point; and
updating the Gaussian distribution curve and the distribution percentage using the ratio multiplier.

7. The method of claim 6, wherein:
the product reliability for each process window segment is calculated for process window segments of the redistributed Gaussian distribution; and
the system product reliability is based on the process window segments of the redistributed Gaussian distribution.

8. The method of claim 7, wherein calculating the system product reliability comprises:
calculating a product reliability for the process window segments of the redistributed Gaussian distribution by multiplying the updated distribution percentage by the product reliability estimation calculated for the process window segments of the redistributed Gaussian distribution; and
summing the product reliability for the process window segments of the redistributed Gaussian distribution.

9. The method of claim 3, further comprising classifying a product based on a voltage bin assignment.

10. A computer program product comprising a computer readable storage memory device having readable program code embodied in the computer readable storage memory device, wherein the computer readable program, when executed on a computing device, is operable to cause the computing device to:
divide a manufacturing process window into process window segments based on an applied planned manufacturing distribution;
identify a system use condition for each process window segment;
calculate an expected amount of product in each of the process window segments, wherein the expected amount is a distribution percentage;
calculate a product reliability estimation for each process window segment based on the system use condition of each respective process window segment; and
calculate a system product reliability estimation based on the product reliability estimation for each process window segment.

11. The computer program product of claim 10, wherein calculating the system product reliability estimation comprises:
calculating a product reliability for each process window segment by multiplying the distribution percentage for each process window segment by the product reliability estimation calculated for each process window segment; and
summing the product reliability for each process window segment.

12. The computer program product of claim 10, wherein the planned manufacturing distribution is a Gaussian distribution curve.

13. The computer program product of claim 12, wherein the computer readable program is further is operable to cause the computing device to:
screen a subset of the process window segments;
calculate a ratio multiplier based on a selected screening point; and
update the Gaussian distribution curve and the distribution percentage using the ratio multiplier.

14. The computer program product of claim 13, wherein:
the product reliability for each process window segment is calculated for process window segments of the updated Gaussian distribution,
the system product reliability estimation is based on the process window segments of the updated Gaussian distribution, and
calculating the system product reliability comprises:
calculating a product reliability for the process window segments of the updated Gaussian distribution by multiplying the updated distribution percentage by the product reliability calculated for the process window segments of the updated Gaussian distribution; and
summing the product reliability for the process window segments of the updated Gaussian distribution.

15. A computer system for calculating a system product reliability estimation, the system comprising:
a CPU, a computer readable memory and a computer readable storage media;
first program instructions to divide a manufacturing process window into process window segments based on an applied planned manufacturing distribution;
second program instructions to identify a system use condition for each process window segment;
third program instructions to calculate an expected amount of product in each of the process window segments, wherein the expected amount is a distribution percentage;
fourth program instructions to calculate a product reliability estimation for each process window segment based on the system use condition for each process window segment; and
fifth program instructions to calculate the system product reliability estimation,
wherein the first, second, third, fourth, and fifth program instructions are stored on the computer readable storage media for execution by the CPU via the computer readable memory.

16. The system of claim 15, wherein calculating the system product reliability estimation comprises:
calculating a product reliability for each process window segment by multiplying the distribution percentage for each process window segment by the product reliability estimation calculated for each process window segment; and
summing the product reliability for each process window segment.

17. The computer system of claim 16, wherein the planned manufacturing distribution is a Gaussian distribution curve.

18. The computer system of claim 17, further comprising:
sixth program instructions to screen a subset of the process window segments; and
seventh program instructions to calculate a ratio multiplier based on a selected screening point; and
eight program instructions to update the Gaussian distribution curve and the distribution percentage using the ratio multiplier.

19. The computer system of claim 18, wherein:
the product reliability estimation for each process window segment is calculated for process window segments of the updated Gaussian distribution; and
the system product reliability estimation is based on the process window segments of the updated Gaussian distribution.

20. The computer system of claim 18, wherein calculating the system product reliability estimation comprises:
calculating a product reliability for the process window segments of the updated Gaussian distribution by multiplying the updated distribution percentage by the product reliability estimation calculated for the process window segments of the updated Gaussian distribution; and
summing the product reliability for the process window segments of the updated Gaussian distribution.
